(19) United States
(12) Patent Application Publication
(10) Pub. No.: US 2002/0000999 A1
(43) Pub. Date: Jan. 3, 2002

(54) Address presentation system interface

(76) Inventors: John M. McCarty, Clifton, VA (US); Michael B. Friedman, Reston, VA (US); Thomas J. B. Clay, Fredrick, MD (US); Vidyadhar Nettimi, Oakton, VA (US); Sabyasachi Bain, Herndon, VA (US); Malathi Sangineni, Reston, VA (US); Lisa F. Hajdo, Sterling, VA (US); Patrick E. Brannen, State college, PA (US); Warren E. Bernard, Bethesda, MD (US)

Correspondence Address: WORLDCOM, INC., TECHNOLOGY LAW DEPARTMENT, 1133 19TH STREET NW, WASHINGTON, DC, 20036, US

(21) Appl. No.: 09/823,432

(22) Filed: Mar. 30, 2001

Related U.S. Application Data
(60) Provisional application No. 60/193,247, filed on Mar. 30, 2000.

(51) Int. Cl. G06F 3/00

(52) U.S. Cl. 345/764

(57) ABSTRACT

An approach for providing retrieval of requested information via a graphical user interface (GUI), which in one embodiment of the present invention, is web-enabled. A user utilizing a client station is able to obtain, for example, telecommunication information based on a user input address information. An address entry screen is provided for inputting address information and specifying desired criteria corresponding to telecommunication information. The address entry screen includes a display size field for inputting map scaling information, and a return-a-map field for requesting a map graphic. A map screen displays the map graphic and the telecommunication information based upon the input address information, the specified desired criteria, and the input map scaling information.

### CROSS-REFERENCES TO RELATED APPLICATION

This application is related to, and claims the benefit of the earlier filing date of U.S. Provisional Patent Application No. 60/193,247, filed Mar. 30, 2000, entitled “Address Presentation System Interface, the entirety of which is incorporated herein by reference.

This application is also related to U.S. Patent Application No. ______ (Attorney Docket No. WMA-00-002), filed on even date herewith and entitled “Address Presentation System,” the entirety of which is incorporated herein by reference.

### BACKGROUND OF THE INVENTION

1. Field of the Invention

The present invention relates to an information processing system, and is more particularly related to a geographic information system supporting location of potential customers and/or facilities relative to existing facilities and/or infrastructure for retail, wholesale, commercial, utilities, or other purposes.

2. Discussion of the Background

Companies seeking to deliver products and/or services to existing or potential customers face a number of challenges relating to decisions as to how best serve customers in a particular geographic region. For example, all types of companies face decisions dealing with provisioning products or services within a particular geographic region by relating address information to existing or potential delivery capabilities. These decisions pose a number of information management challenges with respect to providing products or services to a customer which directly impacts the ability to be competitive and responsive to customers.

For example, telecommunication service providers, which include exchange carriers, access providers, and content providers and the like, face information management challenges with respect to their networks, spanning engineering and marketing organizations. Because telecommunication services are regional in nature, geographic considerations arise throughout the process of providing telecommunications services to a customer. These considerations directly impact the ability to be competitive and responsive to customers.

However, the ability to be competitive and responsive to customers is certainly not unique to telecommunications companies. In fact, these challenges are faced with respect to all entities delivery products and/or services based on: location of customers; location and availability of resources; or any other business-related data or selection criteria related to geographic, such as input address information, or non-geographic information.

Examples of industries facing such challenges include, but are by no means limited to agriculture, forestry, fishing, mining, construction, manufacturing, transportation, communications, electric, gas, sanitary services, wholesale trade, retail trade, finance, insurance, real estate, provision of any services in general, public administration, and nonclassifiable establishments. Additional examples include railroad transportation, local and interurban passenger transit, trucking and warehousing, postal service, water transportation, transportation by air, pipelines, transportation services, and sanitary services, electric utilities, cable television providers, internet service providers. Still further examples include owners of and suppliers of/to: building materials and garden supplies, general merchandise stores, food stores, automotive dealers and service stations, apparel and accessory stores, furniture and home-furnishings stores, eating and drinking places, and miscellaneous retail. The list of product and/or service providers is literally endless.

Yet, what all these providers have in common is the need to better service their existing or potential customers/resources in a particular geographic locale. Traditionally, when companies perform prospecting, market analysis, and network planning the focus has been on using demographic data alone, without factoring in customer location information. As markets for any product or service continue to open up, competition necessarily steers attention to better serving the needs of the customers. All companies in all types of industries seek to delivery products and/or services better, faster, and more efficiently. This enables the company to better ensure their survival as compared to the way their competitors do business in the particular geographic region of interest.

Taking the telecommunications market purely as an example, the needs discussed herein require the telecommunication service providers to target customers with greater precision. Misdirected marketing results in waste of valuable resources. Information regarding service availability and rates within a target area are useful in supporting customers'service requirements. Additionally, knowledge of the locations of the facilities that best serve the target market promotes network efficiency. For instance, in targeting potential customers, product and/or service providers need to know where the best prospects are located. The selection of collocation sites, mapping of service areas, and determination of a prospect's proximity to the local city network are difficult, if not impractical, tasks to perform. Geographic information, thus, play an ever-increasing role in servicing customers. The conventional approach to processing geographic information employs numerous disparate, non-integrated legacy systems to consolidate information on location of facilities, extent of network service coverage, and so on. These legacy systems, from which information are gathered and processed, do not share a standardized interface, and thus, require costly customized development to interact with external systems.

The traditional Bellcore solution to the problem of maintaining spatial (i.e., geographical) information is a combination of vertical and horizontal coordinates and the SAG (Street Address Guide). For example, buildings are located using Bellcore Vertical and Horizontal (V&H) coordinates. In the case of access services, vertical and horizontal coordinates lack granularity because it is a “large area” geographical solution with resolution of one mile. This solution has been adequate for large customers with large orders; however, as telecommunication service providers penetrate smaller markets, geographic inaccuracies will result in increased costs. A number of other industry changes in the local telecommunications service arena, including local number portability, rate center consolidation, and number pooling require a solution that overcomes the deficiencies of a large area geographical system.

For example, placement of long distance facilities have been dictated by the ILEC (Incumbent Local Exchange Carrier) wire center and LATA (Local Access and Transport Area). By and large, the ILEC has been responsible for providing access to the customer location. With the advent of new technologies, such as digital subscriber line (DSL), the emergence of CLECs (Competitive Local Exchange Carriers) has been steady. It is evident that reliance on the ILEC as the source of geographical information is no longer a viable solution as ILECs would inherently be reluctant to assist their competition.

Because of the increased competition, for example, in the local exchange market, the customers are afforded the choice of selecting among a number of telecommunication service providers. However, the customers demand that they be able to maintain their local telephone numbers. Undoubtedly, local number portability presents a key issue to these telecommunication service providers; namely, the new telecommunication service provider has only the phone numbers associated with the incumbent telecommunication service provider for locating appropriate facilities to serve new customers.

The traditional-approach has been to obtain the incumbent-provider's facilities information using the customers' phone numbers, and subsequently mapping such information to the facilities of the new telecommunication service provider. In other words, CLECs have relied on a customer's existing and/or nearby telephone number for switch homing, wire center determination, rate center determination, and the customer's PSAP (Public Safety Answering Point) area; however, the relationship between the customer's NPA/NXX (Numbering Plan Area/3-digit telco central office number) and address continually changes. Consequently, relying on a customer's NPA/NXX to determine a switch service area is not practical in the long-term. It is clear that phone numbers provide an inefficient way to capture spatial information.

Based on the foregoing, there is a clear need in all industries for improved approaches for maintaining geographic information relating to all types of products and service availability, as well as customer availability and location. As stated above, this information is useful in many arenas, and is not limited to use in providing telecommunication services.

There is also a need to provide an integrated system for the retrieval and maintenance of spatial information related to a region of business interest.

There is also a need to minimize development cost by utilizing standardized hardware and software platforms.

There is yet a further need to increase the accuracy and to streamline the processes of prospecting, marketing, and strategic planning of product/service/infrastructure provisioning. Based on the need of prospecting, marketing, and strategic planning of the delivery of products/services and infrastructure, an approach for implementing a geographically enabled information system is highly desirable.

There is also a need for a map-graphic based icon distance calculator that allows for easy distance calculations to transpire, either alone or in conjunction with other aspects of the invention based on relevant geographic or non-geographic information, based upon input address information and specific desired criteria.

There is still further need for a movable map legend associated with a map-graphic to allow for easy positioning of the legend so as not to interfere with viewing presented information. This need extends for use either alone or in conjunction with other aspects of the invention based on relevant geographic or non-geographic information, based upon input address information and specific desired criteria.

There is yet a still further need for a continuous zoom bar associated with a map-graphic to allow for quick and precise zooming of the map-graphic. This need extends for use either alone or in conjunction with other aspects of the invention based on relevant geographic or non-geographic information, based upon input address information and specific desired criteria.

### SUMMARY OF THE INVENTION

The invention, and exemplary embodiments described within, could have application, in whole or in part, in many different utilities and other non-utilities industries, as well as in commercial ventures in general. The examples of uses of the inventions described herein, either as a group or individually, include the telecommunications industry and other utilities to track network or other assets and facilities, to determine placement of new facilities, to determine relevant facilities for a new customer, or to track facilities used by customers. Non-utility industries and other commercial ventures could use individual tools associated with this invention described herein. For example, any industry could benefit from using a push-pin distance calculator for calculating distances between relevant facilities, in single steps ('straight-line') or multiple steps (e.g. street distance); or to present information to customers or potential customers, or to visualize geographic information to display for use in sales, marketing, ordering, or delivery, and so on.

Of course, any other aspects of the present invention may also be used in combination with other industry-specific applications or alone. For example, this invention, with modifications which are clearly understood by those within ordinary skill in the art, would be able to serve non-telecommunications industry areas in addition to the telecommunications industry examples disclosed. Exemplary changes to the telecommunications examples mentioned herein include the trucking and warehousing industry, or the food stores and grocery delivery industry, or even the real estate industry.

In the case of trucking and warehousing, a warehousing company might have specific warehouse facilities locations which store inventory for a given geographic region corresponding in much the same way as the wire center in the exemplary telecommunications embodiments described herein. The invention could be used the determine, based on the input address of the client, which of the warehouses should be used to store the inventory for that client, and therefor which truck dispatch should occur. The invention can be used to plan routes using a push-pin distance calculator based on selected criteria based on geographic and non-geographic data. In the case of food stores, a food store might have specific locations which supply retail food to a given geographic area, corresponding in much the same way as the wire center in the exemplary telecommunications embodiments described herein. The invention could be used to determine, based on the customers address, which food store that customer should visit for their provisions, or which food store should fill the customers'order if it is remotely requested by that customer.

In the case of real estate, a real estate company could designate specific regions, zones, or territories for their real estate agents to work within, corresponding in much the same way as the wire center in the exemplary telecommunications embodiments described herein. Additionally, they could establish certain regions or zones for specific real estate features (e.g., school districts) corresponding to rate centers. The inventions could be used to identify agents with territories in certain school districts; or addresses (listings) in an agent's territory, and so on.

For the specific capabilities, like the push pin tool: the distance calculation capability described herein could be used in industries such as construction. In an industry like construction, the push pin distance calculation tool could be used to measure the street distance along truck routes from interstate exits to job sites in order to ensure trucks are taking the shortest, and likely fastest, path to the designated site. The invention can be used to plan routes using the push-pin distance calculator based on selected criteria based on geographic and non-geographic data. This allows criteria to be considered in route planning, such as whether construction trucks are allowed on certain streets or highways. The push-pin distance calculator can be used either alone or in conjunction with other aspects of the invention relating to the planning of routes based on relevant geographic or non-geographic information, based upon input address information and specific desired criteria.

Another exemplary use of the push-pin distance calculator is for determining distances of marathons, races, an even for tax purposes related to mileage, either alone or in conjunction with other aspects of the invention relating to the planning of routes based on relevant geographic or non-geographic information, based upon input address information and specific desired criteria.

Another specific capability includes a movable map legend that can be used, either alone or in conjunction with other aspects of the invention relating to the planning of routes based on relevant geographic or non-geographic information, based upon input address information and specific desired criteria. The movable map legend allows a user to move a map legend within a user interface, and have the legend return to the position the legend was placed last by the particular user.

Yet another specific capability includes a continuous zoom bar that can be used in conjunction with or separate from a system that provides the industry-specific information relative to a geographic region. The continuous zoom bar allows a user to position an input device such as a cursor over a zoom bar which has a level of zoom associated with the position within the zoom bar. This feature allows users to easily specify the level of zoom.

According to one aspect of the invention, a method is provided interfacing with a computer by a user, the method comprising: providing a map screen comprising a map graphic; and placing a plurality of push-pin icons on the map graphic to initiate an actual distance calculation between actual locations represented by relative positions of the plurality of push-pin icons and the map graphic. A similar computer-readable medium is provided, as is a device, both for performing similar functionality as the method. Furthermore, according to another aspect of the invention, a device is provided, comprising: a communication interface including a processor; and a graphical user interface (GUI) coupled to the communication interface, the GUI comprising, a map screen comprising a map graphic, wherein the map screen is configured to display a distance calculation based upon placement of a plurality of push-pin icons on the map graphic. Under these arrangements, users can accurately determine distance calculations.

According to yet another aspect of the invention, a method of interfacing with a computer by a user is provided, the method comprising: providing a map screen comprising a map graphic; displaying a map legend associated with the map graphic; and moving the map legend within the map screen. A similar computer-readable medium is provided, as is a device, both for performing similar functionality as the method. Furthermore, according to another aspect of the invention, a device is provided, comprising: a communication interface including a processor; a graphical user interface (GUI) coupled to the communication interface, the GUI comprising, a map legend associated with the map graphic; and a memory, operatively coupled to the computing device, that stores placement of the map legend within the map screen. The map graphic has a map legend that is movable within the map screen. Under these approaches, spatial information are retrieved expediently.

According to still yet another aspect of the invention, a method of interfacing with a computer by a user is provided, the method comprising providing a map screen comprising a map graphic; providing an indication of the zoom of the map graphic by positioning a cursor along a zoom bar. A similar computer-readable medium is provided, as is a device, both for performing similar functionality as the method. Furthermore, according to another aspect of the invention, a device is provided, comprising: a communication interface including a processor; and a graphical user interface (GUI) coupled to the communication interface, the GUI comprising, a map screen configured to display a zoom indication of the map graphic by positioning a cursor along a zoom bar. Under these approaches, users can easily specify the level of zoom.

These approaches advantageously enhance business processing of any type of product and/or service, whether it is related to utility services such as telecommunications, or the broad array of business applications discussed above. An example of the universal application of the inventive subject matter includes any type of product or service sales distribution resource. The map and requested information may relate to location of existing customers, potential customers, consumers of related or non-related products/service, location of product, location of sales personal, location of sales facilities, and so on. The possibilities are endless. Many of the examples described herein relate to utilizing address information converting the information to geospatial information, and relating the geospatial information to other information for comparison purposes. However, it is readily understood by one of ordinary skill in the art that this invention has applicability to any other industry and would be readily adaptable thereto without undue experimentation using the principles described herein.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of the hardware architecture of the address presentation system (APS), in accordance with an embodiment of the present invention;

FIG. 2 is diagram of the software architecture of the system of FIG. 1;

FIG. 3 is a diagram illustrating the operation of the APS of FIG. 1;

FIG. 4 is a flow chart of the address validation and geocoding process, according to an embodiment of the present invention;

FIG. 5 is an address entry screen of a graphical user interface (GUI) of the APS, according to an embodiment of the present invention;

FIGS. 6A and 6B are a map and information screen of a GUI, according to an embodiment of the present invention;

FIG. 6C is a flow chart of the distance calculation operation supported by the GUI of FIG. 6B;

FIG. 7 is a diagram of a map legend in the GUI of FIG. 6A;

FIG. 8 is an address entry screen of a GUI, according to an embodiment of the present invention;

FIG. 9 is a retrieved information screen of a GUI indicating unavailability of service, according to an embodiment of the present invention;

FIGS. 10A and 10B are a retrieved information screen of a GUI indicating availability of service, according to an embodiment of the present invention;

FIG. 11 is a failed address validation screen of a GUI, according to an embodiment of the present invention;

FIG. 12 is a diagram of the data structure used in the address presentation system of FIG. 1; and

FIG. 13 is a diagram of a computer system that can perform in accordance with an embodiment of the present invention.

### DESCRIPTION OF THE PREFERRED EMBODIMENTS

In the following description, for the purpose of explanation, specific details are set forth in order to provide a thorough understanding of the invention. However, it will be apparent that the invention may be practiced without these specific details. For instance, repeated use of telecommunications-related products/services are used to provide a consistent exemplary industry application, but are in no way intended to limit the scope of the invention to applicability to only this industry since universal application to any other product/service arena is intended. In some instances, well-known structures and devices are depicted in block diagram form in order to avoid unnecessarily obscuring the present invention. Although the present invention is discussed with respect to exemplary protocols, computer languages, and operating systems, the inventions can be implemented on any computer system regardless of protocols, languages, or operating system platform.

The present invention accomplishes effective retrieval of spatial information relating to, for example, telecommunication services and associated networks by utilizing a robust client/server architecture. Through a web client application, the user specifies various requested relevant geographic or non-geographic information regarding telecommunication facilities, services, and so on (collectively referred to as telecommunication information) and inputs address information into an address presentation system (APS). In turn, the APS sends a map, if requested, along with the requested telecommunication information to a client station, which displays the map and the requested information via a robust and intuitive graphical user interface (GUI). Among other functional capabilities, the GUI provides extensive zooming functionalities, distance calculation using “push-pin” icons, a user-customizable movable map legend, and map redraw capability within a single screen. The APS also supports desktop applications with targeted functionality, so that spatial information can be readily obtained through many types of client applications. The APS is based upon standards compliant client/server architecture, which includes an application server (e.g., web server) and a database server. Additionally, the APS utilizes a Common Object Request Broker Architecture (CORBA), thereby permitting any CORBA compliant system to utilize the resources of the APS.

Although the present invention is discussed with respect to exemplary protocols, computer languages, and operating systems, the APS can be implemented on any computer system regardless of protocols, languages, or operating system platform. Furthermore, it is recognized by one of ordinary skill in the relevant art that the present invention relates to gathering any type of information in general, even though the present invention is discussed with respect to telecommunication information.

The APS is a geographic information system that supports, for example, telecommunication service providers in their mission to deploy telecommunication services and to manage their network infrastructure. In general terms, the APS is an organized collection of computer hardware, software and geographic data that provides entry, storage, query and display of geographic reference information related to facilities and service coverage.

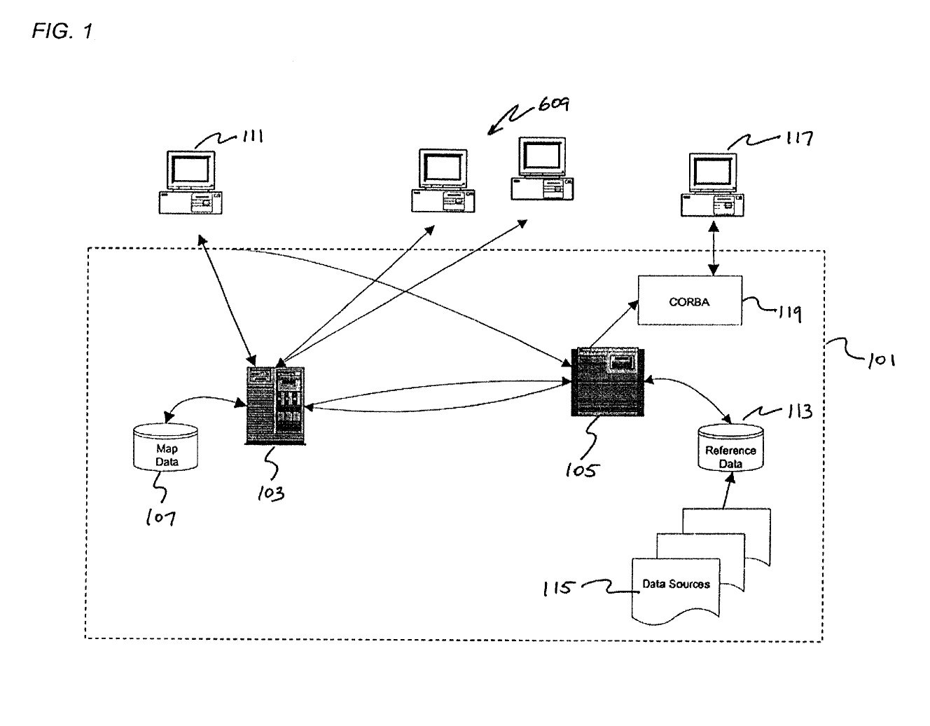

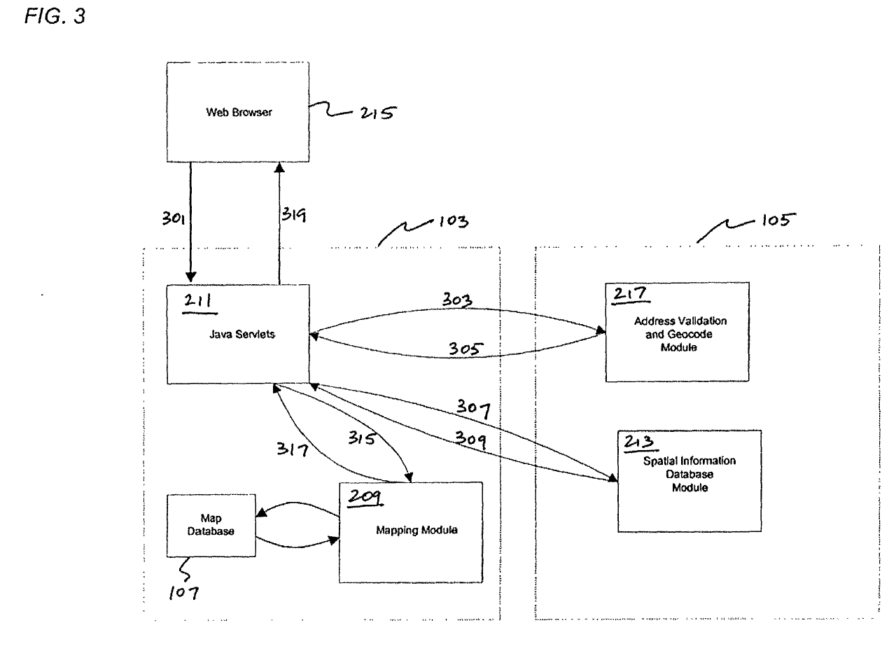

FIG. 1 shows the hardware architecture of the APS, in accordance with an embodiment of the present invention. The APS system 101 includes a web server 103 that communicates with a database server 105 over, for example, a local area network (LAN) (not shown). The web server 103 interfaces with a map database 107 to retrieve map data; according to one embodiment, the database 107 resides within the web server 103 itself (as shown in FIG. 3). Alternatively, the database 107 can be situated external to the web server 103. In an exemplary embodiment, the web server 103 is a server-class IBM-compatible running the Microsoft Windows NT operating system.

The APS 101 provides a web application that returns a map and associated attribute information (e.g., telecommunication information) based on user input of a service address (e.g., city/state/zip code, street address/zip, or and so on). The input address is validated and mapped to reference information, which, according to one exemplary embodiment, includes rate centers, ILEC wire centers, on-ring and LIT/CAP (Competitive Access Provider) buildings, switch information, and switch collocation (COLLO) information. A wire center is the geographic serving area of an end office (or central office) that describes the location of the local loop between the customer and the first (highest numeric class) switch. Traditionally, the end office has been limited by the maximum transmission length of copper wires. Rate center pertains to telephone company-designated geographic locations assigned vertical and horizontal coordinates between which mileage are determined for the charging of private lines. That is, the distance between two rate centers is used to compute the charge rates for telecommunication services provided in the area between the rate centers. COLLO information pertains to the facilities of a third party where a piece of equipment of the telecommunication service provider resides.

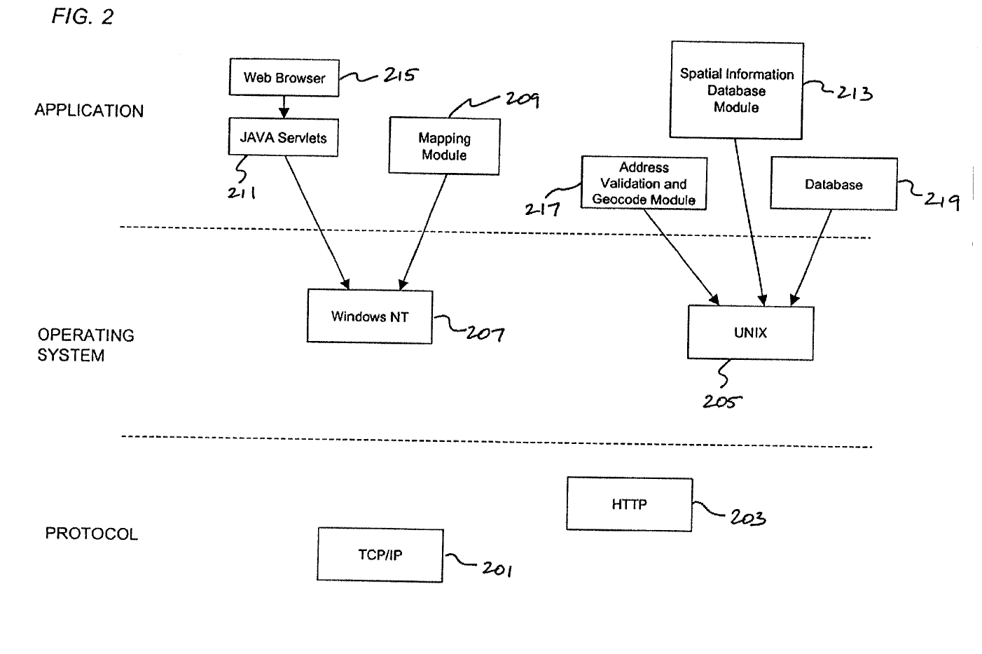

To retrieve, for example, requested telecommunication information, client stations 109 access the web server 103 using standardized web browsers (e.g., Microsoft Internet Explorer, Netscape, and so on); this retrieval operation is more fully discussed in FIG. 3. To serve these client stations 109, web server 103 executes JAVA applications (e.g., JAVA servlets). JAVA provides operating system independence, enabling language flexibility and code-reuse. Additionally, the web server 103 supports non-web enabled client stations, such as client station 111, via a mapping module application, which is more fully discussed in FIG. 2.

As described above, the APS 101 supports two deployments: (1) a client/server solution, and (2) a web application. In the client/server distribution, desktop mapping software (e.g., MapInfo Professional) is loaded on a client station 111 to access the spatial information within APS 101. The desktop geographic application enables the user to perform complex geographic analysis by processing the information provided by the web server 103 and the database server 105.

The database server 105 operates on a UNIX platform (e.g., HP-UX 10.20 by Hewlett-Packard); according to one embodiment, the hardware is a Hewlett-Packard server (e.g., T-class). The database server 105 interacts with database 113, which stores information (e.g., telecommunication information such as wire centers, rate centers, PSAP, LIT/CAP, switch locations) from a myriad of data sources 115. The data sources 115, in one embodiment, include commercially available data (e.g., rate center, wire center, PSAP, customer demographic information) as well as data from the information systems of the telecommunication service provider (e.g., switch information, switch collocation information, and CAP buildings). As used herein, the term telecommunication information include information from these data sources 115. (A myriad of non-telecommunication information may also be used in another embodiment of the invention accordance with other industries seeking to relate address information to data sources about regions which have access to or near the address.) Furthermore, the APS 101 interfaces with many external systems (not shown) using CORBA 119. Specifically, (as seen in the figure) client station 117 can access information from database server 105 using CORBA 119.

The architecture of the APS 101 enables the return of a standard API (Application Programming Interface) that outputs all pertinent geographic information. This approach advantageously reduces development and implementation time for new interfaces to other systems by leveraging an existing multi-purpose (or generic) API, rather than requiring new development for each new system interface. Additionally, APS 101 brings the power of geographical based analysis and decision support tools to client stations 109, 111, and 117. These aspects are very helpful in applying the concepts described with respect to the telecommunications examples to other applications in a variety of industries.

As a geographical information system, APS 101 defines three distinct types of geographical information: (1) points, (2) lines, and (3) polygons. APS 101 provides the client stations 109, 111, and 117 with the ability to query this “spatial” data; for example, to map an input address to a rate center (a point to a polygon), determine the distance from a building to a switch (point to point) or view all collocation switches within a serving wire center (point to polygon). A spatial query combines geographic polygons, lines and points; this information can be represented by different icons on a map, displayed as text on a screen, or distributed to other systems via a messaging interface. Once again, these options allow easy transition from the telecommunications examples provided herein to applications in other industries.

JAVA applications coupled with CORBA compliant middleware enables object to object communication between the objects in client and server roles. Middleware is software that is transparent to a user, which takes two or more applications and makes them work seamlessly together. With middleware technology, a user can design an ordinary component to provide its regular function, and then insert an appropriate middleware mix when the component is built or created at run time. In a CORBA environment, an Object Request Broker (ORB) receives request for services of software modules from programs on clients (e.g., client stations 109, 111, and 117) and servers 103 and 105. The JAVA/CORBA ORB middleware enables distribution of objects, making the APS 101 appear as a single system.

In a CORBA environment, a program makes a request for services of software modules through an ORB, and thus, does not need to know the design and composition of the program, which includes the software. In client/server applications, an ORB is an interface to which the client station 117 makes a request for service from a software object, which in this case is within database server 105. The ORB then directs the request to the server (e.g., server 105) hosting the software object and returns the resulting value(s) of the service to the client (e.g., client station 117).

In an object-oriented programming environment, a client is defined as a member of a class or group that uses the services of another class or group to which the client is not related by way of inheritance from a common class or group. More generally, a client is a software module that requests a service provided by another software module. The client uses the requested service without having to know any working details about the other software module or the service. In a network environment, a server is defined as a computer or program that responds to commands from a client.

CORBA software objects are components of intelligence that may reside anywhere on a network. They are packaged as binary components which remote clients may access via method invocations. Both the language and compiler used to create server software objects are transparent to clients. Clients have no need to know where the distributed software object resides or on what operating system it executes. The distributed software object may be in the same process or on a machine that sits across a large network. Additionally, clients have no need to know how a server software object is implemented. For example, a server software object may be implemented, for example, as a set of JAVA classes, or it may be implemented as a large COBOL (Common Business-Oriented Language) program. The client only needs to know the interface its server software object publishes. The interface then serves as a binding contract between client stations 109, 111, and 117 and servers 103 and 105.

Such interface specifications are written in a neutral Interface Definition Language (IDL) that defines a component's boundaries; that is, its contractual interfaces with potential clients.

Components written to IDL are accessible across languages, tools, operating systems, and networks.

IDL-specified methods can be written in and invoked from any language that provides CORBA bindings. Examples of such languages include JAVA, C, C++, Ada and Smalltalk. Programmers interact with CORBA software objects using native language constructs. IDL provides operating system and programming language independent interfaces to all the services and components that reside on a CORBA bus. This allows client and server software objects written in different languages to communicate with one another. OMG IDL is utilized to specify a component's attributes, the parent classes from which the component inherits, the exceptions it raises, the typed events it emits, and the methods its interface supports, including the input and output parameters and their data types. The CORBA IDL allows component providers to specify in a standard definition language the interface infrastructure of the software objects that they provide.

The CORBA Object Request Broker is the software object bus. As previously indicated, the ORB enables software objects to transparently make requests to, and receive responses from, other software objects located locally or remotely. The client is not aware of the mechanisms used to communicate with, activate, or store these server software objects. A CORBA ORB provides a wide variety of distributed middleware services. The ORB allows software objects to discover each other at run time and invoke each other's services. An ORB is much more sophisticated than alternative forms of client/server middleware, including traditional Remote Procedure Calls (RPCs), Message-Oriented Middleware, database stored procedures, and peer-to-peer services. Nevertheless, all these alternative forms could be implemented by one skilled in the art to achieve equivalent functionalities.

FIG. 2 shows the software architecture of the APS, according to one embodiment of the present invention. The client stations 109, 111, and 117 and the servers 103 and 105 run TCP/IP (Transmission Control Protocol/Internet Protocol) 201 to communicate among themselves as well as to other external systems (not shown). In particular, web server 103 communicates with database server 105 over a TCP/IP socket. Client station 111 also uses TCP/IP to exchange information with database server 105. One of ordinary skill in the art would recognize that other transport layer protocols can be utilized (e.g., User Datagram Protocol (UDP)).

As web clients, client stations 109 employ the Hypertext Transfer Protocol (HTTP) 203 to exchange information with web server 103. HTTP 203 is an application-level protocol for distributed, collaborative, hypermedia information systems; IETF (Internet Engineering Task Force) RFC (Request for Comment) 2616 specifies this protocol and is incorporated by reference herein in its entirety. HTTP 203 advantageously provides development or modification of the APS 101 independent of the data being transferred.

According to one embodiment, the two primary operating systems supported by APS 101 are UNIX 205 and Microsoft Windows NT 207. Database server 105 runs UNIX 205 in the form of HP-UX 10.20, which complies with the following standards: X/Open's Single UNIX Specification (SPEC1170); X/Open Portability Guide, Issue 4 (XPG4); (System V Interface Definition, Issue 3 (SVID3) level 1 APIs; Open Software Foundation (OSF) Application Environment Specification (AES); and Common Desktop Environment (CDE) standard. Windows NT 207 is run on web server 103.

The APS 101 utilizes a number of applications to provide efficient retrieval of requested information, such as telecommunication information for example. In particular, the web server 103 contains a mapping module 209 as well as a variety of JAVA servlets 211. The JAVA servlets 211 provide interaction with a web browser 215 on the client station (e.g., client stations 109). The mapping module 209 permits the overlay of telecommunication information from the database server 105 onto a map with street level detail. In an exemplary embodiment, the street map is StreetPro by MapInfo. As will be described more fully in FIG. 3, the mapping module 209 generates a map graphic based upon the received telecommunication information. The mapping module 209, according to one embodiment of the present invention, is the mapping application server MapXtreme by MapInfo. The mapping module 209 provides connectivity to live data sources 115 by interfacing with the spatial information database module 213 within database server 105. The mapping module 209 provides the capability to draw customized objects onto a map and to display a specific point on the map (based upon address information). Additionally, the mapping module 209 supports spatial selection, whereby a specific location and its associated spatial data can be selected for examination. The location can be specified for example according to a rectangular area, a radial area, or a polygon.

The database server 105 runs UNIX 205 to support the spatial information database module 213 and an address validation and geocode module 217. The database server 105 implements a relational database 219, for example, Informix 9. It is recognized that other relational database platforms (e.g., ORACLE 8.05) can be used in the APS 101. The spatial information database module 213 enables the integration of spatial data with the existing data of database 219 by providing a SQL (Structured Query Language) database for spatial operations. Additionally, data from the data sources 115 can be efficiently and rapidly loaded onto the database 113 by the spatial information database module 213, which further supports the mapping module 209 in web server 103. According to one embodiment of the present invention, the spatial information database module 213 is SpatialWare DataBlade by MapInfo; optionally, it is recognized by one of ordinary skill in the art that other equivalent spatial technology products can be utilized.

Furthermore, the database server 105 possesses an address validation and geocode module 217 to provide address validation and geocoding. The term geocoding, as used herein, denotes determination of positional information based upon address information; the positional information may be any of latitude and longitude coordinates, Cartesian coordinates, spherical coordinates, polar coordinates, and so on. The operational details of the address validation and geocode module 217 are discussed below in FIG. 3. In terms of its functional capabilities, the address validation and geocode module 217 validates an input address by comparing it with address ranges within a United States Postal Service (USPS) address ZIP+4 database, and subsequently, outputs a validated address (which is in standard format according to the USPS address ZIP+4 database). The address validation and geocode module 217 then geocodes the validated address, returning positional information (e.g., latitude and longitude) to the web server 103. In an exemplary embodiment, the address validation and geocode module 217 includes the CODE-1 Plus software by Group 1 Software to perform the address validation. This operation as well as the operation of the overall APS 101 is described in FIG. 3.

FIG. 3 shows the operation and interaction among the software modules of the APS 101. In step 301, a client station 109 submits an input address via the web browser 215 to the web server 103, which has a JAVA servlet 211 that processes the input address. The address, as in step 303, is transmitted by the web server 103 to the database server 105, where the address is validated and geocoded by the address validation and geocode module 217. In turn, the address validation and geocode module 217 outputs a validated address and positional information (e.g., latitude and longitude) to the web server 103 (step 305). In step 307, a JAVA servlet (e.g., MapXtreme servlet (MAPJ)) accesses the spatial information database module 213 to query the database 113 (e.g., Informix database). Exemplary queries are as follows: point-in-polygon to rate_center for rate_center_name and boundary, point-in-polygon to wire_center for wire_center_name, point-in-polygon for PSAP name and boundary, CAP buildings, and switches and collocation switches in the rate_center. In step 309, the database server 105 returns a mapped object to the web server 103. The web server 103, as in step 311, accesses the map data 107 via the mapping module 209. Thereafter, map data 107 is retrieved (step 313). In an exemplary embodiment, the map data 107 is street data layer associated with MapInfo StreetPro. In step 315, all spatial data are processed by the mapping module 209, which renders a map graphic (e.g., GIF (Graphical Interchange Format) file). The map graphic, per step 317, is sent to the JAVA servlets 211, for transmission to the web browser 215 (step 319).

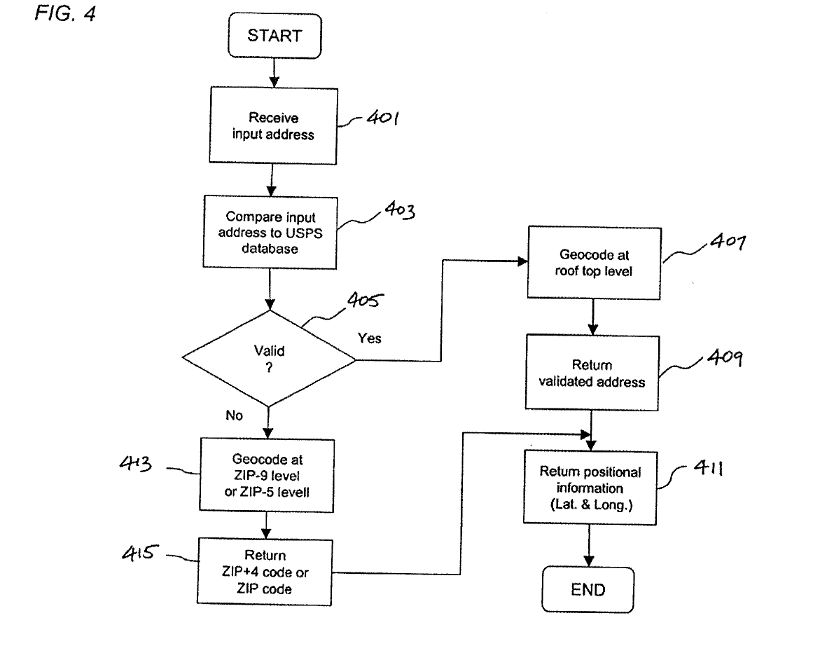

FIG. 4 shows a flow chart of the address validation and geocoding process performed by the address validation and geocode module 217. In general, the address validation process validates an input address and then geocode on a rooftop level of precision. If the input address fails validation, the address validation and geocode module 217 attempts to determine positional information (e.g., latitude and longitude) at the ZIP-9 level, and then the ZIP-5 level (the ZIP-9 level exhibiting greater than ZIP-5 precision because the location area is narrower). In step 401, the input address is received. The address validation and geocode module 217, as in step 403, compares the input address with the addresses in the USPS database (not shown). Next, in step 405 the address validation and geocode module 217 determines whether a match is found in the USPS database; if a match is found, the address is valid. Upon determination that a valid USPS address exists, this validated address is geocoded at the rooftop level to yield the latitude and the longitude. The validated address is returned to the web server 103 (step 409); thereafter, as in step 411, the positional information is also sent to the web server 103. However, if the input address is invalid, then the address validation and geocode module proceeds to geocode either at the ZIP-9 level (i.e., with the precision of all nine ZIP digits) or the ZIP-5 level, depending on the closest address match (step 413). The ZIP code (5 digits) or ZIP+4 code (9 digits), per step 415, is forwarded to the web server 103. Under this scenario, the latitude and longitude information can represent the center of the ZIP code area, according to one embodiment of the present invention.

Other embodiments include attributing the latitude and longitude information to other characteristics of the ZIP code area, such as for example, the center of concentration of the population associated with the ZIP code. Alternatively, other attributes for returning a match in step 413 may be based on any information related to application in a particular industry. For example, road location and traffic volume near a particular latitude and longitude associated with an input address may be useful to a particular industry. This example might be of use in any industry determining where to locate an aspect of their business (e.g., gasoline station, customer service center of agents, product sales site, and so on).

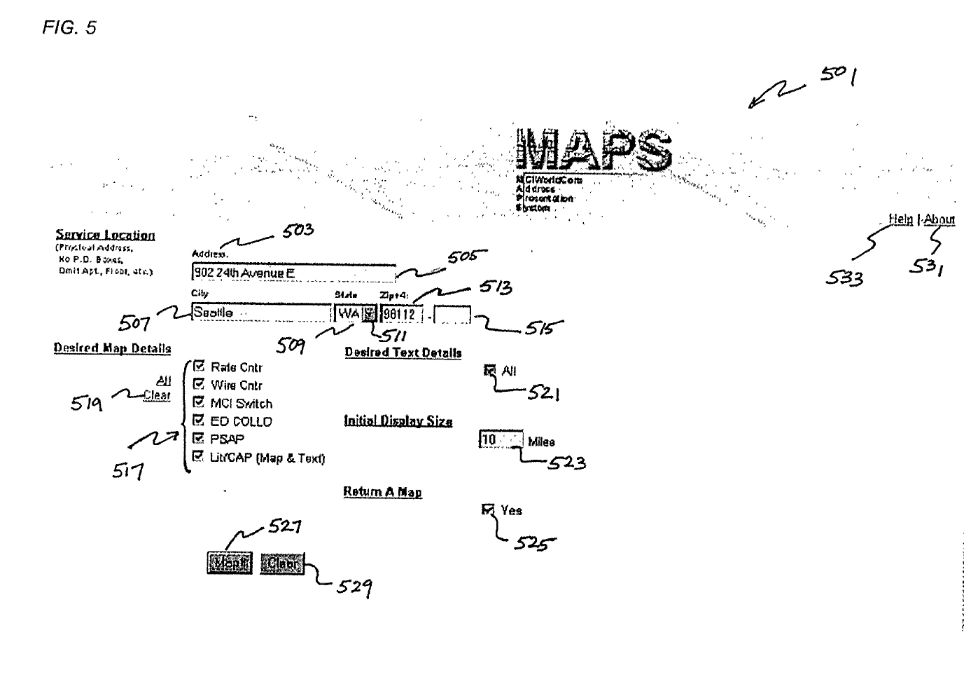

FIG. 5 shows a GUI that provides a user with a mechanism to enter an address of a service location. According to an embodiment of the present invention, the GUI is an address entry screen 501 that is supported by a web browser 215 on a client station (e.g., client stations 109). The address entry screen 501 includes an address field 503 with a text box 505 for entering street information. Another text box 507 permits entry of the city of the service location. The address entry screen 501 also has a pull-down text box 509 to designate the state of the service location. The user may enter the abbreviation of the state directly in box 509 or click on an arrow 511 to trigger a scrolling list of state abbreviations. The ZIP+4 code field has two text boxes 513 and 515 for entry of the 5-digit ZIP code and the 4-digit extension, respectively. Any of the fields 505, 507, 509, 513 and 515 can be made optional, so long as an individual field or a combination thereof permits the address validation and geocoding process performed by the database server 105 to return valid positional information.

As seen in FIG. 5, the address entry screen 501 displays a number of selection criteria in form of check boxes 517 that corresponds to various information, e.g., telecommunication information. However, as mentioned previously, any type of information can be processed; for instance, a manufacturer can maintain product information with the APS 101 based upon demographics of the region. As an additional example, a courier service may wish to manage its distribution channels; in this manner, distribution hubs and their coverage areas can be easily determined. According to one embodiment of the present invention, the selection criteria include the following: rate center (Rate Cntr); wire center (Wire Cntr); switch of a particular telecommunication service provider, e.g., MCI (MCI Switch); end-office collocation switch (EO COLLO); public safety access point (PSAP); and LIT and CAP building (LIT/CAP). LIT/ CAP buildings denote facilities in which the telecommunication service provider has agreements with other CLECS Competitive Access Providers (CAP) to provide access and lease equipment. A building may have many CAPs associated with it. LIT building signifies that the building is ready to carry traffic and that the customer is ready to provision service.

In an exemplary embodiment, the user can check any one or number of boxes 517 based upon the telecommunication information that is desired. Also, any one of these check boxes 517 can be checked as a default. Checking of each selection criteria boxes determines that particular map layers that are to appear on the generated map graphic. An “All Clear” field 519 unchecks all the boxes 517.

As shown, an “All” check box 521 associated with the Desired Text Details field allows the user to designate whether all available telecommunication information corresponding to the checked boxes 517 should be retrieved. In accordance with one embodiment of the present invention, the All check box 521 is programmed to always be checked; thus, as a default, the APS 101 returns all the text details of the telecommunication information. The address entry screen 501 additionally permits the user to enter a value in text box 523, which is associated with the Initial Display Size field, thereby, specifying the scale of the map that is to be generated by the web server 103. According to this example, the value represents miles. The range of this value depends on the sizing and capacity of the APS 101; in an embodiment of the present invention, the range is from 1 to 200 miles. A Yes check box 525 of the Return A Map field permits the user to indicate whether a map graphic is to be generated. If the Yes check box 525 is unchecked, text of the telecommunication information will be displayed, without the map graphic.

The address entry screen 501 has two buttons 527 and 529, which are labeled “MapIt” and “Clear”, respectively. The Clear button 529 clears all the fields 503, 505, 507, 509, 513, and 523 and all the check boxes 517, 521, and 523. That is, the Clear button 529 essentially clears and refreshes the screen 501 for a new address. The MapIt button 527 initiates the query to the APS 101 to create a map and display telecommunication available for a particular service location as indicated by the input address information.

The About field 531 on the upper right-hand comer of the address entry screen 501 provides a brief description of the APS 101 as well as version information. Also on the upper right-hand comer is a Help field 533 that refers the user to an online APS User Guide, which provides explanatory information on the address entry screen 501 as well as other information on the APS 101.

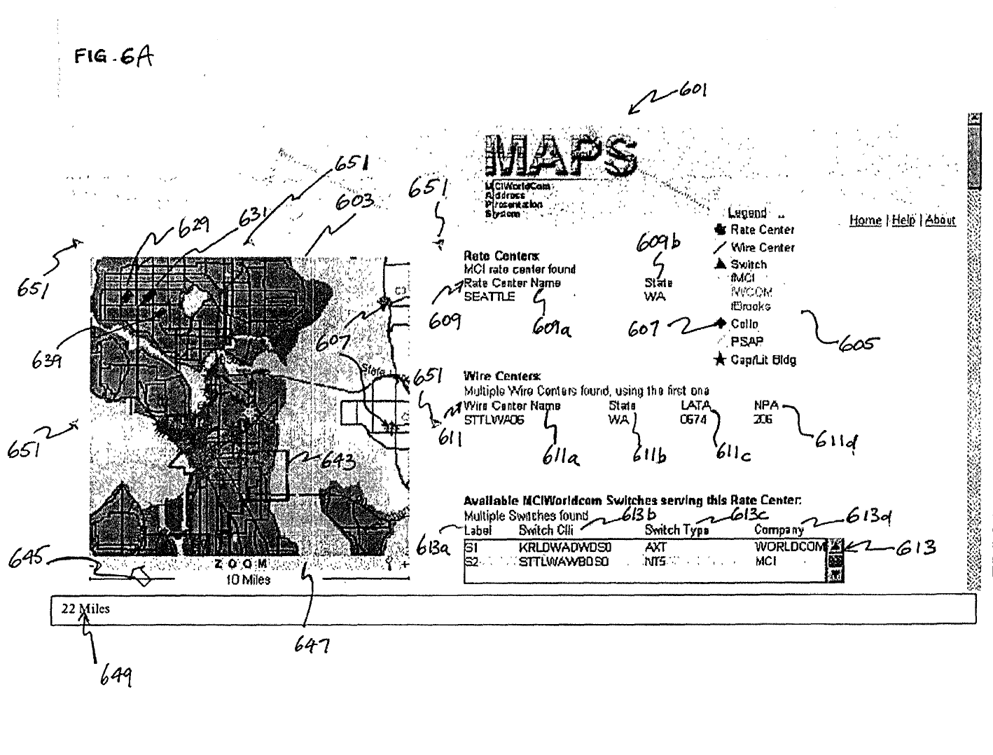

FIGS. 6A and 6B show a map and information screen 601 of the GUI, which is displayed based upon address information and the specified selection criteria of the address entry screen 501. Assuming the user has indicated that a map graphic is to be generated by checking box 525 and has selected all the available selection criteria boxes 517, a map and information screen 601 (as shown in FIG. 6B) is displayed to the user on the client station 109. FIG. 6A shows the first view of the map and information screen 601; upon scrolling to the end of the map and information screen 601, a client station displays the view shown in FIG. 6B. The map and information screen 601 includes a map graphic 603 that illustrates the service location (as specified by the input address) at a street level. The scale of the map graphic 603 corresponds to the value of the display size in box 523, which, in this example, is 10 miles.

The map graphic 603 contains the overlay of icons representing the telecommunication information corresponding to the chosen selection criteria. The map and information screen 601 includes a map legend 605 to identify these icons. For example, a diamond icon 607 denotes a location of the collocation switch within the area of the service location.

The telecommunication information, in text form, are displayed in text box 609 of the g rate centers, text box 611 of the wire centers, text box 613 of the MCI switches, text box 615 of the collocation switches, text box 617 of the PSAP, and text box 619 of the CAP/LIT buildings. The map and information screen 601 automatically displays scroll bars for these text boxes (e.g., 613, 615, 617, and 619) if the telecommunication information in the respective categories exceed a predetermined number of lines. That is, frames are used to display information, as appropriate. In this case, the telecommunication information relating to rate centers and wire centers occupy only a single line each; their respective text boxes 609 and 611 do not have scroll bars. It should be noted that screen 601 may represent a map graphic apart from, or in combination with, other information, and any other information need not be displayed with the map graphic.

When information is displayed, such as for example, the telecommunication information, it is associated with each of the selection criteria are specific to the exemplary category. The fields of the Rate Centers text box 609 include the Rate Center Name field 609a and the State field 609b. The Wire Centers box 611 has a Wire Center Name field 611a, a State field 611b, a LATA (Local Access and Transport Area) field 611 c, and an NPA (Numbering Plan Area) field 611d. The switch information text box 613 includes a Label field 613a to identify the switch, a switch CLLI (Common Language Location Identification) code field 613b, a Switch Type field 613c, and a Company field 613d to indicate the company that owns the respective switch. The collocation switch text box 615 encompasses the following fields: a Label field 615a to identify the collocation switch, a COLLO CLLI field 615b, a Within WC (wire center) field to indicate whether the collocation switch falls within the boundary of the wire center, and a Distance From Input Point field 615d to specify the distance from the input address to the particular collocation switch. The PSAP text box 617 includes an Agency field 617a to identify the particular agency, a Coverage field 617b to specify the area of coverage of the PSAP, a FIPS field 617d, a County field 617e, and a Routing Number field 617e to specify the number that the emergency number is translated to (or resolved to).

To inform the user on the information that has been provided to the APS 101, the map and information screen 601 displays the selection criteria check boxes 517 of the Desired Map Details field as well as the input address information 621 (as shown in FIG. 6B), which is the actual search address used in the address validation and geocoding process. Additionally, the map and information screen 601 provides a USPS Validated Address field 623, which includes a ZIP+4 code. It should be noted that if no valid address is found, an appropriate message is displayed under the USPS Validated Address field 623; for example, “None Found.” The Latitude and Longitude field 625 is displayed; in this example, this positional information has been calculated with rooftop precision. The map and information screen 601 has a ReDrawMap button 627, which triggers the regeneration of the map graphic 603. The user can click on the ReDrawMap button 627, for example, if different selection criteria are desired or the map graphic 603 display size has been altered.

In addition to the map and attributes listed above, APS 101 can provide distance information from the input address to, for example, switch, collocation switch and building locations. Distance information can be provided either from a straight-line perspective or along the streets from the starting address to the destination. With APS 101, the user also has the flexibility to perform running distance calculations from one point on the map to another, with any number of intermediate points; this operation is more fully described below with respect to FIG. 6C.

The APS 101 is designed to support a number of business functions (e.g., the order entry process). As an illustration, customer service representatives (CSRs) routinely need to determine the distance from the customer location to an ILEC end office for DSL (Digital Subscriber Line) provisioning and the distance from CAP and on-ring buildings for near ring solutions. With the distance calculation capability, the CSRs are able to make the distance determination quickly.

The map and information screen 601 enables distance calculation using the map graphic 603. Specifically, the user can designate numerous points on the map graphic 603 for distance calculation by placing two or more icons (which, in an exemplary embodiment, resemble push-pins) onto the map graphic 603. The distance calculation is performed in two ways: (1) between a latest push-pin and the immediately preceding push-pin (i.e., current distance); and (2) from the first push-pin through the last push-pin including all intermediate push-pins (i.e., cumulative distance). In other words, the current distance indicates calculated distance from the previous point to the last point. The cumulative distance indicates total road distance from the starting point through the last point. Alternatively, straight-line distances are calculated directly from the first push-pin to the most-recently positioned push-pin, that need not be a road-distance calculation.

FIG. 6C shows a flow chart of the distance calculations, in accordance with an embodiment of the present invention. The ability to place the push-pins 629, 631, and 639 (as shown in FIG. 6B) is triggered by first clicking on Distance button 633 (step 671). In step 673, the user places a first push-pin and a second push-pin; for example, the user places a starting push-pin 629, and an intermediate push-pin 631 (FIG. 6B). Next, as in step 675, the current distance is calculated and displayed based upon the placement of the push-pins 629 and 631. Additionally, the cumulative distance is calculated and displayed, per step 677. At this point, the Current Distance field 635 and the Cumulative Distance field 637 would show equal values. If the user has not completed tracing out a route (step 679), the user places another push-pin onto the map graphic 603 (step 681). Upon placing the last push-pin 639, the Current Distance field 635 would display the distance between the intermediate push-pin 631 and the last push-pin 639, while the Cumulative Distance field 637 would show the cumulative distance from push-pin 629 to push-pin 631 plus the distance from push-pin 631 to push-pin 639. If the user has finished tracing out a route, the process ends. As seen in FIG. 6B, a Reset button 641 clears the Current Distance field 635 and the Cumulative Distance field 637, eliminating any push-pin icons on the map graphic 603. The distance calculation functionality advantageously provides a mechanism to easily trace out a route and determine its distance, which is useful in effecting engineering changes or answering service availability inquiries.

The map and information screen 603 also provides expansive zooming capabilities: rectangular zooming, and zooming via a zoom bar. The user can elect to draw a rectangle 643 of any size within the map graphic 603; a subsequent map graphic 603 is generated with a scale corresponding to the size of the rectangle 643. Alternatively, the user can position a cursor 645 along a zoom bar 647, in which a zoom distance 649 is concurrently displayed corresponding to the position of the cursor 645. In this embodiment, the zoom bar 647 provides the ability to specify continuous zoom values (shown as zoom distance 649). Alternatively, the zoom bar 647 can be configured to specify discrete zoom values corresponding to discrete areas depicted in the zoom bar 674. Upon positioning the cursor 645 over an area of the zoom bar 647 corresponding to the desired level of zoom, as reflected by zoom distance 649, the user can select this level of zoom, for example, by clicking a mouse (not shown) The map and information screen 601 further supports panning of the map graphic 603 via directional icons in form of pan arrows 651.

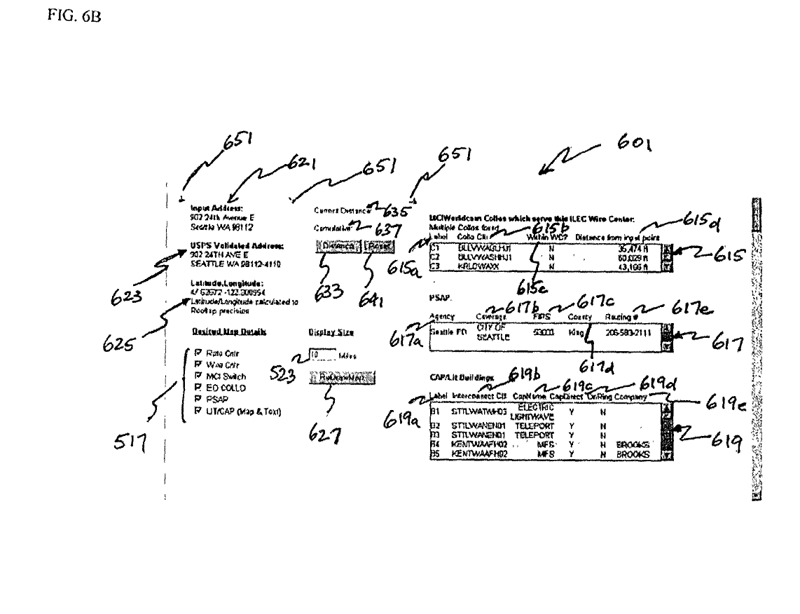

FIG. 7 shows a large view of the map legend 605. The map and information screen 601 permits the user to move the map legend 605 about the screen 601 (FIG. 6A) so that the user can customize where the map legend 605 should be situated. The APS 101 retains this customization by the user so that the map and information screen 601 will display the map legend 605 at the location where the user last specified. In other words, the APS 101 stores information regarding the location of the map legend 605 for each individual user independently for each such users; accordingly, the location information of the map legend 605 is retrieved by the APS 101 in a subsequent user session. Effectively, other users can move the map legend 605 according to their preferences without imposing any particular preference to another user. The map legend 605 can also be minimized to avoid obstructing significant portions of the map and information screen 601.

In view of the functionalities discussed above, the APS 101 supports a number of critical functions within an organization, the exemplary the telecommunication service provider. These functions can include prospecting, sales and marketing, network planning, site or agent location, product distribution, and service provisioning. The APS 101 permits visually targeting prospective customers based on proximity to, for example, LIT/CAP buildings and switches to determine the lowest access cost. Additionally, the APS 101 also supports identification of clusters of prospects with high revenue potential. The APS 101 ensures that no prospects will be targeted in municipalities that cannot be served by telecommunication service provider, without excluding surrounding or overlapping rate centers.

Further, the sales and marketing department can utilize APS 101 to identify the correct rate center based on physical location rather than NPA/NXX. As such, by using the information retrieved by the APS 101, the telecommunication service provider can minimize the number of rejected orders arising from incorrect switch and NPA/NXX assignment. APS 101 also provides the sales organization the capability to identify the services available for a location (e.g., HDSL (High-bit-rate Digital Subscriber Line)), which is only available to customers within 12,000 feet of a switch). Further, the sales organization can rapidly identify the correct PSAP area so that E911 service routing and dispatch is set up correctly. The marketing organization of the telecommunication service provider, using APS 101, can define key business areas (tariff areas, promotional areas, and so on). As indicated above, the APS 101 has applicability to non-telecommunication services. A food delivery service business or door-to-door sales organization, for instance, can quickly tell a potential customer whether the customer's residence falls within the service area.

With respect to service provisioning of telecommunication services, the APS 101 provides the following support functions: determination of the most cost-effective service delivery method to use by basing this selection on address rather than NPA/NXX, and determination of which switches/collocation switches a customer can be provisioned to based on serving wire center or LATA. The APS 101 also supports the capability to provision service based upon “political” considerations in that the APS 101 can filter and/or sort out information with respect to deployment of services requiring the use of a competitor's facilities, services, and so on. For example, the collocation switches can be prioritized according to the third party telecommunication service provider (or vendor). In a competitive environment, it is preferred that a telecommunication service provider utilize the facilities or services of another provider that poses the least threat to the telecommunication service provider's market position. A weighting function can be applied to all providers in a service area to prioritize preferred providers over, for example, competitors. Additionally, the engineering organization can utilize APS 101 to plan and manage network growth. Specifically, APS 101 permits network planners with the capability to identify the best place to locate new facilities for a target market.

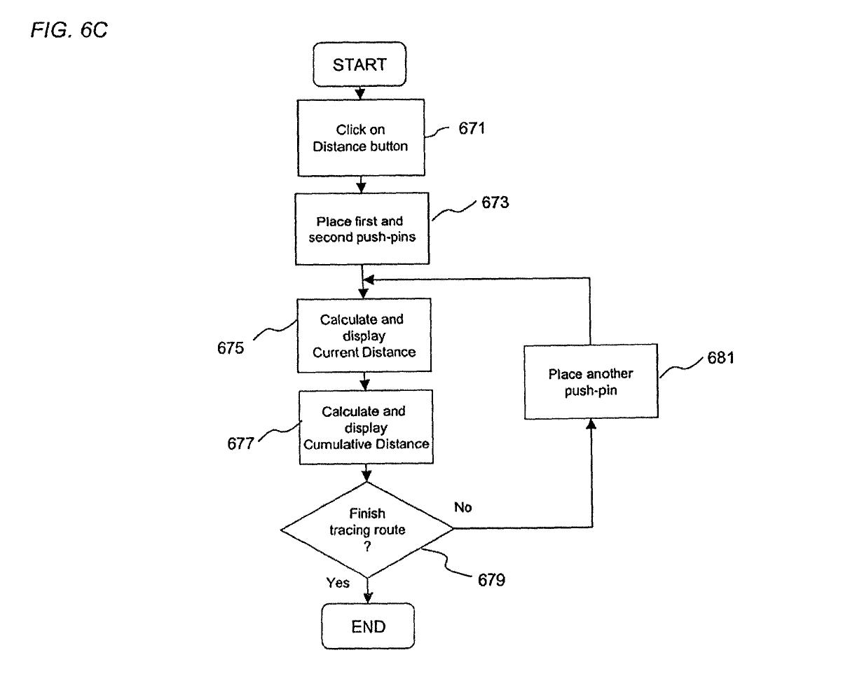

The APS 101 provides a more targeted GUI for rapidly obtaining specific telecommunication information. FIG. 8 shows a GUI, according to an embodiment of the present invention, which is used to determine service availability with respect to a particular location. The GUI includes two screens: a service location address entry screen, and a service availability result screen. In this example, the service is HDSL, which is a distance dependent service. Similar to the address field of the address entry screen 501, as discussed above, the service location address entry screen 801 has an address text box 803 for the street, a city text box 805 for the city, a state pull-down text box 807 for the state, and ZIP+4 text boxes 807 and 811. A Clear button 815 is provided to allow the user to clear all the entry text boxes 803, 805, 807, 809, and 811. The user launches the query to the APS 101 by clicking a Go button 813.

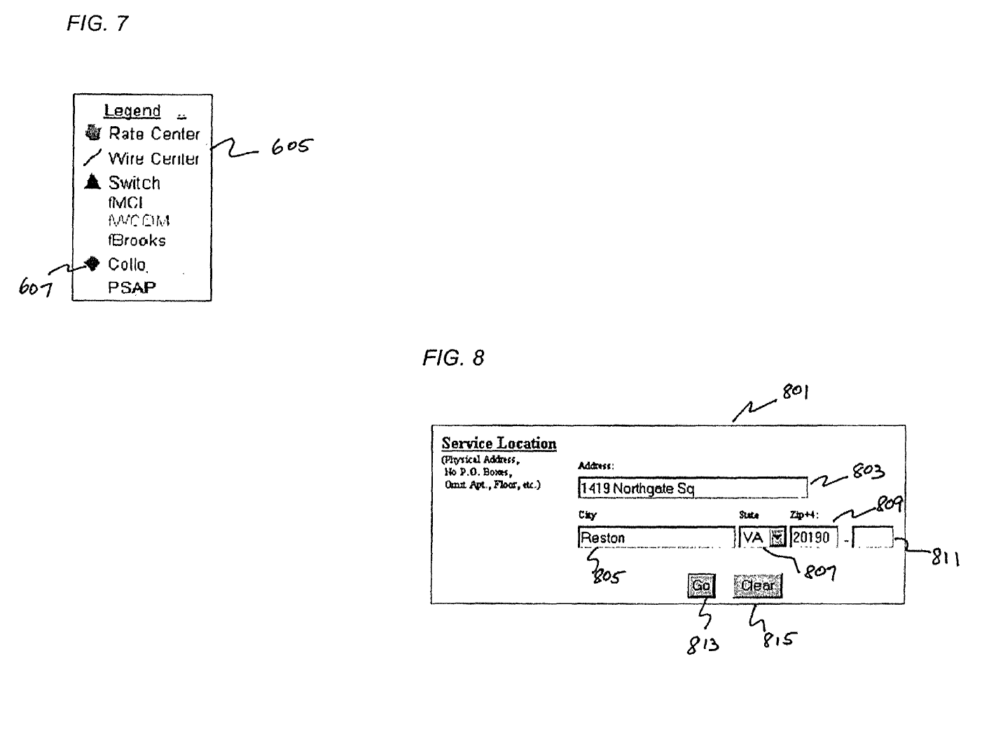

FIG. 9 shows a service availability result screen 901, according to one result scenario (i.e., service is not available). The service availability result screen 901 displays an Input Address field 903 to repeat the address information that was entered by the user as a way to ensure that the user has entered the correct address information. Next to the Input Address field 903 is a Validated Address field 905. Additionally, the positional information is captured in the Latitude and Longitude field 907. The telecommunication information that was obtained from the APS 101 include the identity of the wire center that is nearest the service location (as specified by the input address) under the Wire Center field 909, the collocation switch that is HDSL capable under the HDSL Capable Collocation switches field 911, and a Within Range field 913 to indicate whether the HDSL is within range of the service location. The service F availability result screen 901 also provides a text box 915 to provide a detailed description of why the service is not available.

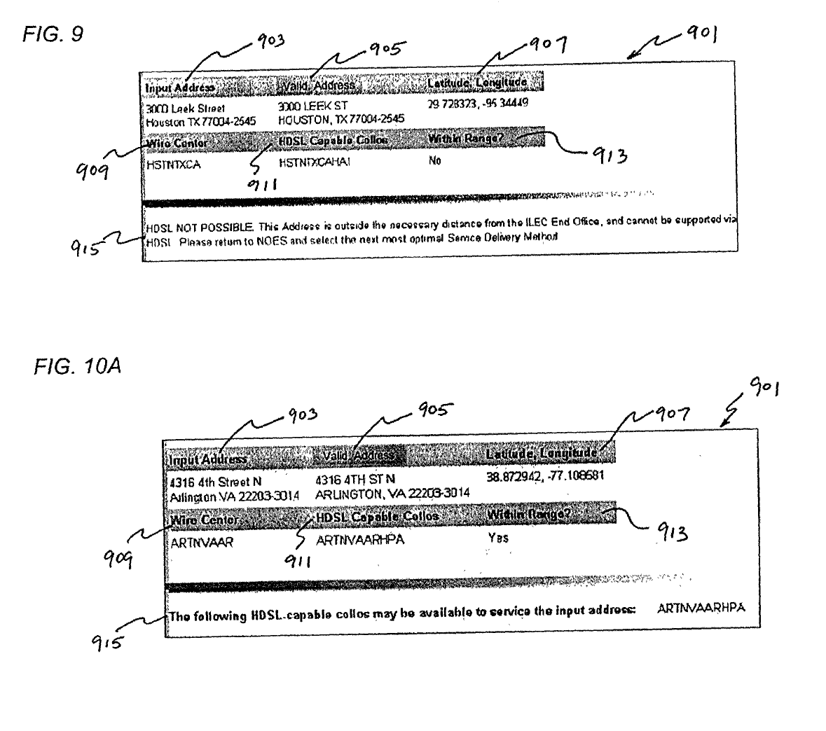

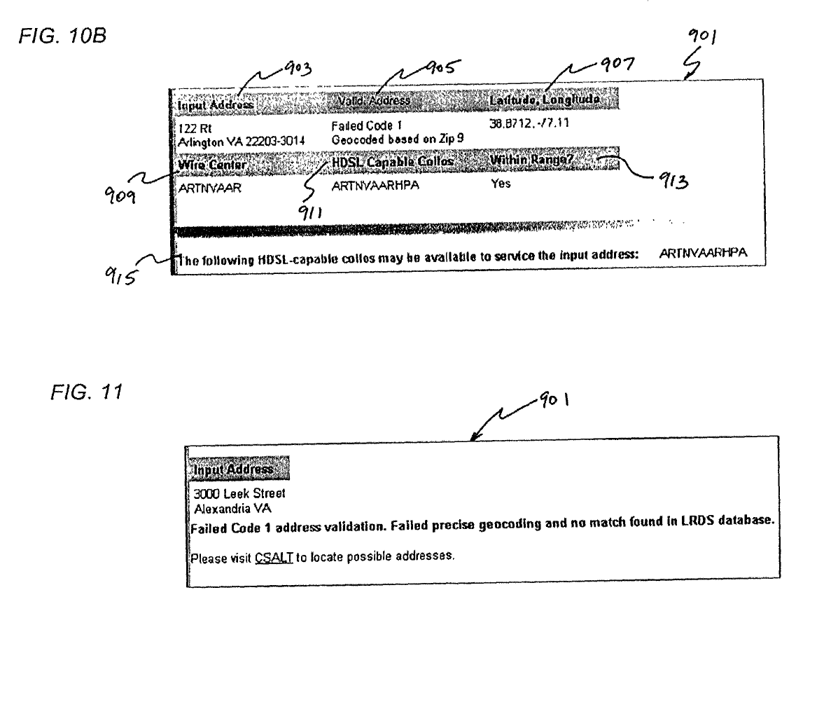

FIGS. 10A and 10B show the service availability result screens under two different scenarios in which service has been indicated as available. FIG. 10A shows the case where HDSL is available in the service location specified, as evident by the Within Range field 913. In FIG. 10B, the input address failed validation; therefore, the validated address is based upon ZIP-9. FIG. 11 illustrates the case in which the input address also failed USPS address validation. This scenario differs from that of FIG. 10B because geocoding cannot be performed based on ZIP-9 or ZIP-5.

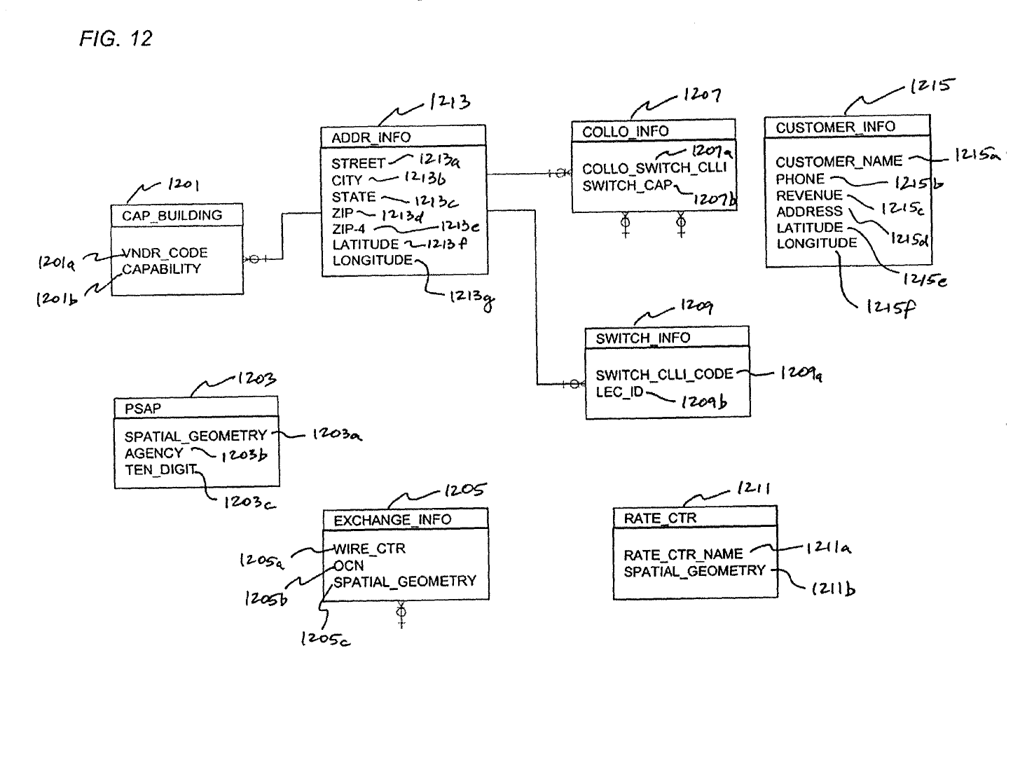

FIG. 12 shows a data model used in the address presentation system, according to an embodiment of the present invention. It is recognized by one of skilled in the art that the particularities of the data definitions are not needed to implement the APS 101; these particularities can be tailored and defined according to the design requirements of the telecommunication service provider. The APS 101 utilizes a number of tables associated with the telecommunication information, as follows: CAP_BUILDING table 1201, PSAP table 1203, EXCHANGE_INFO table 1205, COLLO_INFO table 1207, SWITCH_INFO table 1209, and RATE_CTR table 1211. The APS 101 also use an ADDR_INFO table 1213 and a CUSTOMER_INFO table 1215.

The three key polygon type tables are the EXCHANGE_INFO table 1205, the RATE_CTR table 1211, and the PSAP table 1203. The EXCHANGE_INFO table 1205 pertains to the wire center boundary and includes the following fields: a WIRE_CTR field 1205a, an OCN (Operating Company Number) field 1205b, and a SPATIAL-GEOMETRY field 1205c. The RATE_CTR table 1211 has a RATE_CTR_NAME field 1211a and a SPATIAL_GEOMETRY field 1211b. The PSAP table 1203, which provides spatial data for the PSAP area, has a SPATIAL_GEOMETRY field 1203a, an AGENCY field 1203b for the identity of the agency, and a TEN_DIGIT_NO field 1203c for storing the ten-digit phone number that the emergency number translates into. Each of the SPATIAL_GEOMETRY fields 1203a, 1205c, and 1211b contains a spatial description for the respective polygon.

The tables that provide point data are the CAP_BUILDING table 1201, the ADDR_INFO table 1213, the COLLO_INFO table 1207, and the SWITCH_INFO table 1209. The CAP_BUILDING table 1201 stores fields relating to the CAP buildings. These fields include the following: a VNDR_CODE field 1201a for vendor code, which identifies the vendor of the equipment; and a CAPABILITY field 1201b for indicating various attributes of the equipment within the building (e.g., capacity). The CAP_BUILDING table 1201 has a one-to-many relationship with the ADDR_INFO table 1213. The ADDR_INFO table 1213 has the following fields: STREET field 1213a, CITY field 1213b, STATE field 1213c, ZIP field 1213d for the 5-digit ZIP code, a ZIP-4 field 1213e for the 4-digit extension, a LATITUDE field 1213f, and a LONGITUDE field 1213g. The COLLO_INFO table 1207 includes a COLLO_SWITCH_CLLI field 1207a for storing the CLLI of the collocation switch, and a SWITCH_CAP field 1207b for specifying the capabilities of the particular switch. The SWITCH_INFO table 1209 has a SWITCH_CLLI_CODE field 1209a for storing the CLLI of the switch and a LEC_ID field 1209b for storing the identity of the LEC (Local Exchange Carrier) associated with the particular switch. The COLLO_INFO table 1207 and the SWITCH_INFO table 1209 are both related to the ADDR_INFO table 1213 in that the addresses of the collocation switch and the switch are maintained.

The CUSTOMER_INFO table 1215 provides information on existing and prospective customers of the telecommunication service provider. The CUSTOMER_INFO table 1215 has the following fields: a CUSTOMER_NAME field 1215a, a PHONE field 1215b, a REVENUE field 1215c for indicating the revenue that the customer generates for the telecommunication service provider, an ADDRESS field 1215c, a LATITUDE field 1215d, and a LONGITUDE field 1215e. Essentially, the CUSTOMER_INFO table 1215 stores customer information that enable a more targeted marketing effort.

Each of the above examples illustrate the flexibility of the present invention. As shown above, any variety of detailed information may be used in a system such as that described herein for use in any industry for decisions such as, for example, prospecting, sales and marketing, network planning, site or agent location, product distribution, and service provisioning.

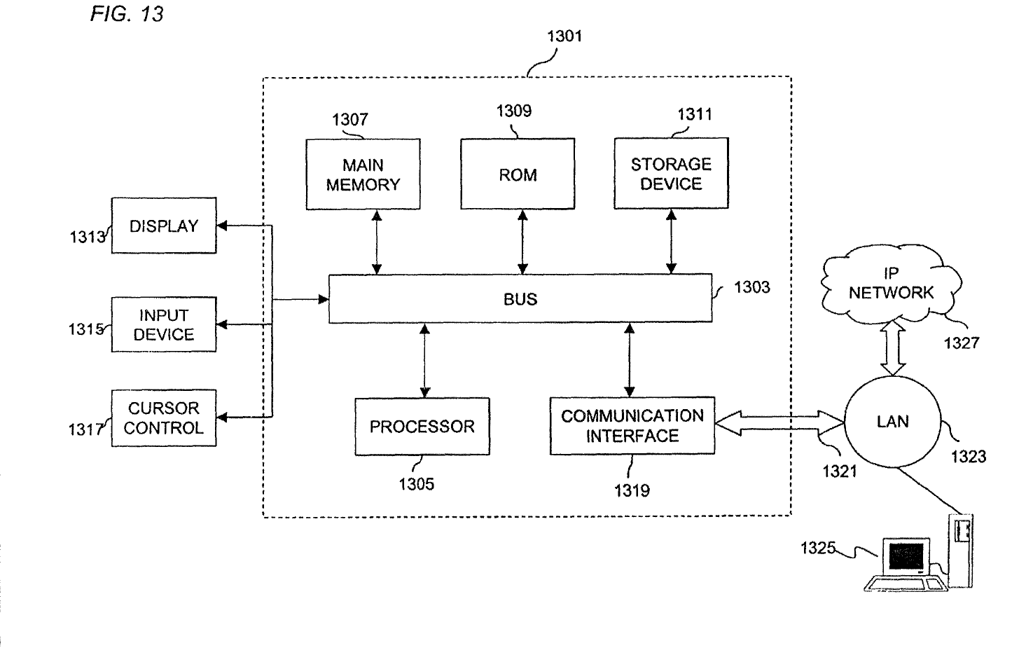

FIG. 13 illustrates a computer system 1301 upon which an embodiment according to the present invention may be implemented. Computer system 1301 includes a bus 1303 or other communication mechanism for communicating information, and a processor 1305 coupled with bus 1303 for processing the information. Computer system 1301 also includes a main memory 1307, such as a random access memory (RAM) or other dynamic storage device, coupled to bus 1303 for storing information and instructions to be executed by processor 1305. In addition, main memory 1307 may be used for storing temporary variables or other intermediate information during execution of instructions to be executed by processor 1305. Computer system 1301 further includes a read only memory (ROM) 1309 or other static storage device coupled to bus 1303 for storing static information and instructions for processor 1305. A storage device 1311, such as a magnetic disk or optical disk, is provided and coupled to bus 1303 for storing information and instructions.

Computer system 1301 may be coupled via bus 1303 to a display 1313, such as a cathode ray tube (CRT), for displaying information to a computer user. An input device 1315, including alphanumeric and other keys, is coupled to bus 1303 for communicating information and command selections to processor 1305. Another type of user input device is cursor control 1317, such as a mouse, a trackball, or cursor direction keys for communicating direction information and command selections to processor 1305 and for controlling cursor movement on display 1313.

According to one embodiment, displaying the GUI screens 501 and 601 is provided by computer system 1301 in response to processor 1305 executing one or more sequences of one or more instructions contained in main memory 1307. Such instructions may be read into main memory 1307 from another computer-readable medium, such as storage device 1311. Execution of the sequences of instructions contained in main memory 1307 causes processor 1305 to perform the process steps described herein. One or more processors in a multi-processing arrangement may also be employed to execute the sequences of instructions contained in main memory 1307. In alternative embodiments, hard-wired circuitry may be used in place of or in combination with software instructions. Thus, embodiments are not limited to any specific combination of hardware circuitry and software.

Further, the data structure of FIG. 12 may reside on a computer-readable medium. The term “computer-readable medium” as used herein refers to any medium that participates in providing instructions to processor 1305 for execution. Such a medium may take many forms, including but not limited to, non-volatile media, volatile media, and transmission media. Non-volatile media includes, for example, optical or magnetic disks, such as storage device 1311. Volatile media includes dynamic memory, such as main memory 1307. Transmission media includes coaxial cables, copper wire and fiber optics, including the wires that comprise bus 1303. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1305 for execution. For example, the instructions may initially be carried on a magnetic disk of a remote computer. The remote computer can load the instructions relating to displaying the GUI screens 501 and 601 remotely into its dynamic memory and send the instructions over a telephone line using a modem. A modem local to computer system 1301 can receive the data on the telephone line and use an infrared transmitter to convert the data to an infrared signal. An infrared detector coupled to bus 1303 can receive the data carried in the infrared signal and place the data on bus 1303. Bus 1303 carries the data to main memory 1307, from which processor 1305 retrieves and executes the instructions. The instructions received by main memory 1307 may optionally be stored on storage device 1311 either before or after execution by processor 1305.

Computer system 1301 also includes a communication interface 1319 coupled to bus 1303. Communication interface 1319 provides a two-way data communication coupling to a network link 1321 that is connected to a local network 1323. For example, communication interface 1319 may be a network interface card to attach to any packet switched local area network (LAN). As another example, communication interface 1319 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 1319 sends and receives electrical, electromagnetic and/or optical signals that carry digital data streams representing various types of information.

Network link 1321 typically provides data communication through one or more networks to other data devices. For example, network link 1321 may provide a connection through local network 1323 to a host computer 1325 or to data equipment operated by a service provider, which provides data communication services through an IP (Internet Protocol) network 1327 (e.g., the Internet). LAN 1323 and IP network 1327 both use electrical, electromagnetic or optical signals that carry digital data streams. The signals through the various networks and the signals on network link 1321 and through communication interface 1319, which carry the digital data to and from computer system 1301, are exemplary forms of carrier waves transporting the information. Computer system 1301 can transmit notifications and receive data, including program code, through the network(s), network link 1321 and communication interface 1319.

The techniques described herein provide several advantages over prior approaches to providing and processing spatial data associated with telecommunication information. The APS 101 provides the user the ability to select the type of spatial geography and telecommunication information via a robust and user-friendly GUI. The APS 101 returns a map that displays the selected information for the geographic area, along with the accompanying textual data. The user is able to run geographic queries in an ad-hoc mode to answer a wide range of engineering and business problems.

Obviously, numerous modifications and variations of the present invention are possible in light of the above teachings. It is therefore to be understood that within the scope of the appended claims, the invention may be practiced otherwise than as specifically described herein.

What is claimed is:

1. A method of interfacing with a computer by a user, the method comprising:
providing a map screen comprising a map graphic; and
placing a plurality of push-pin icons on the map graphic to initiate an actual distance calculation between actual locations represented by relative positions of the plurality of push-pin icons and the map graphic.

2. The method according to claim 1, wherein the actual distance calculation comprises:
converting a first address associated with a first position on the map graphic of a first push-pin icon into a first geocode;
converting a second address associated with a second position on the map graphic of a second push-pin icon into a second geocode; and
calculating the actual distance between the first and the second geocodes.

3. The method according to claim 1, wherein the providing step further comprises displaying at least one of current distance information and cumulative distance information.

4. The method according to claim 3, wherein the providing step further comprises displaying at least one of current distance information represented between any consecutively placed push-pin icons, and cumulative distance information represented between an originally placed push-pin icon and a most-recently placed push-pin icon.

5. The method according to claim 4, wherein the current distance information is measured as a straight-line distance represented between any consecutively placed push-pin icons.

6. The method according to claim 4, wherein the cumulative distance information is measured as a straight-line distance represented between the originally placed push-pin icon and the most-recently placed push-pin icon.

7. The method according to claim 3, wherein said cumulative distance information is measured as a sum of distances between consecutively placed push-pin icons.

8. The method according to claim 1, further comprising providing an address entry screen for inputting address information and the providing map screen step is based on address information associated with the plurality of push-pin icons.

9. The method according to claim 8, wherein the step of providing the address entry screen comprises:
displaying a return-a-map field for requesting the map graphic; and
selectively displaying the map graphic based upon the input address information.

10. The method according to claim 1, wherein the step of providing the map screen comprises displaying a redraw map icon for refreshing the map graphic.

11. The method according to claim 1, wherein the step of providing the map screen comprises displaying validated address information corresponding to the input address information.

12. The method according to claim 11, wherein the step of providing the map screen further comprises displaying positional information corresponding to the validated address information.

13. The method according to claim 12, wherein the positional information in the step of displaying positional information comprises latitude/longitude information.

14. The method according to claim 1, wherein the step of providing the map screen further comprises requesting information including at least one of wire center data, rate center data, PSAP (Public Safety Answering Point) data, CAP (Competitive Access Provider) data, switch collocation data, and switch location data.

15. The method according to claim 1, wherein the step of providing the map screen comprises displaying a plurality of directional icons for panning around the map graphic.

16. A computer-readable medium carrying a sequence of instructions for interfacing with a computer by a user, the sequence of instructions including instructions which, when executed by a processor, cause the processor to perform the steps of:
providing a map screen comprising a map graphic; and
placing a plurality of push-pin icons on the map graphic to initiate an actual distance calculation between actual locations represented by relative positions of the plurality of push-pin icons and the map graphic.

17. The computer-readable medium according to claim 16, wherein the actual distance calculation comprises:
converting a first address associated with a first position on the map graphic of a first push-pin icon into a first geocode;
converting a second address associated with a second position on the map graphic of a second push-pin icon into a second geocode; and
calculating the actual distance between the first and the second geocodes.

18. The computer-readable medium according to claim 16, wherein the providing step further comprises displaying at least one of current distance information and cumulative distance information.

19. The computer-readable medium according to claim 18, wherein the providing step further comprises displaying at least one of current distance information represented between any consecutively placed push-pin icons, and cumulative distance information represented between an originally placed push-pin icon and a most-recently placed push-pin icon.

20. The computer-readable medium according to claim 19, wherein the current distance information is measured as a straight-line distance represented between any consecutively placed push-pin icons.

21. The computer-readable medium according to claim 19, wherein the cumulative distance information is measured as a straight-line distance represented between the originally placed push-pin icon and the most-recently placed push-pin icon.

22. The computer-readable medium according to claim 18, wherein said cumulative distance information is measured as a sum of distances between consecutively placed push-pin icons.

23. The computer-readable medium according to claim 16, further comprising providing an address entry screen for inputting address information and the providing map screen step is based on the address information associated with the plurality of push-pin icons.

24. The computer-readable medium according to claim 23, wherein the step of providing the address entry screen comprises:
displaying a return-a-map field for requesting the map graphic; and
selectively displaying the map graphic based upon the input address information.

25. The computer-readable medium according to claim 20, wherein the step of providing the map screen comprises displaying a redraw map icon for refreshing the map graphic.

26. The computer-readable medium according to claim 20, wherein the step of providing the map screen comprises displaying validated address information corresponding to input address information.

27. The computer-readable medium according to claim 26, wherein the step of providing the map screen further comprises displaying positional information corresponding to the validated address information.

28. The computer-readable medium according to claim 27, wherein the positional information in the step of providing the map screen comprises latitude/longitude information.

29. The computer-readable medium according to claim 20, wherein the step of providing the map screen further comprises requesting information including at least one of wire center data, rate center data, PSAP (Public Safety Answering Point) data, CAP (Competitive Access Provider) data, switch collocation data, and switch location data.

30. The computer-readable medium according to claim 20, wherein the step of providing the map screen comprises displaying a plurality of directional icons for panning around the map graphic.

31. A computing device, comprising:
interface means for graphically interfacing between a user and said computing device; and
distance calculation means for calculating an actual distance between actual locations represented by relative positions of a plurality of push-pin icons placed on the interface means.

32. A computing device, comprising:
a communication interface including a processor; and
a graphical user interface (GUI) coupled to the communication interface, the GUI comprising,
a map screen comprising a map graphic, wherein the map screen is configured to display a distance calculation based upon placement of a plurality of push-pin icons on the map graphic.

33. The computing device according to claim 32, wherein the map screen is further configured to selectively display a map graphic.

34. The computing device according to claim 32, wherein the processor is configured for initiating an actual distance calculation between locations represented by relative positions of the plurality of push-pin icons and the map graphic.

35. The computing device according to claim 32, wherein the processor is configured for displaying at least one of current distance information and cumulative distance information.

36. The computing device according to claim 35, wherein the processor is configured for displaying at least one of current distance information represented between any consecutively placed push-pin icons, and cumulative distance information represented between an originally placed push-pin icon and a most-recently placed push-pin icon.

37. The computing device according to claim 36, wherein the current distance information is measured as a straight-line distance represented between any consecutively placed push-pin icons.

38. The computing device according to claim 36, wherein the cumulative distance information is measured as a straight-line distance represented between the originally placed push-pin icon and the most-recently placed push-pin icon.

39. The computing device according to claim 36, wherein said cumulative distance information is measured as a sum of distances between consecutively placed push-pin icons.

40. The computing device according to claim 32, wherein the processor is configured for providing an address entry screen for inputting address information and providing map graphic based on the address information.

41. The computing device according to claim 40, wherein the processor is configured for providing the address entry screen by performing the steps comprises:
displaying a return-a-map field for requesting the map graphic; and
selectively displaying the map graphic based upon the input address information.

42. The computing device according to claim 32, wherein the map screen displays a redraw map icon to refresh the map graphic.

43. The computing device according to claim 40, wherein the map screen displays validated address information corresponding to the input address information.

44. The computing device according to claim 43, wherein the map screen displays positional information corresponding to the validated address information.

45. The computing device according to claim 44, wherein the positional information comprises latitude/longitude information.

46. The computing device according to claim 32, wherein the map screen is further configured to display requested information comprising at least one of wire center data, rate center data, PSAP (Public Safety Answering Point) data, CAP (Competitive Access Provider) data, switch collocation data, and switch location data.

47. The computing device according to claim 32, wherein the map screen displays a plurality of directional icons to pan around the map graphic.

48. A method of interfacing with a computer by a user, the method comprising:
providing a map screen comprising a map graphic;
displaying a map legend associated with the map graphic; and
moving the map legend within the map screen.

49. The method of claim 48, further comprising storing a last placement position of the map legend for replacement of the map legend at the last placement position upon subsequent use of the map screen.

50. The method according to claim 49, wherein said storing a last placement is user-dependent such that a first user may store a separate location of said map legend independent of another location stored by a second user.

51. The method according to claim 48, wherein the step of providing the map screen comprises displaying a redraw map icon for refreshing the map graphic.

52. The method according to claim 48, wherein the map screen further comprises an input address field that, upon input of address information, determines display of the map graphic.

53. The method according to claim 52, wherein the step of providing the map screen comprises displaying validated address information corresponding to the input address information.

54. The method according to claim 53, wherein the step of providing the map screen further comprises displaying positional information corresponding to the validated address information.

55. The method according to claim 54, wherein the positional information in the step of displaying positional information comprises latitude/longitude information.

56. The method according to claim 48, wherein the step of providing the map screen further comprises requesting information relating to at least one of wire center data, rate center data, PSAP (Public Safety Answering Point) data, CAP (Competitive Access Provider) data, switch collocation data, and switch location data.

57. The method according to claim 48, wherein the step of providing the map screen comprises displaying a plurality of directional icons for panning around the map graphic.

58. A computer-readable medium carrying a sequence of instructions for interfacing with a computer by a user, the sequence of instructions including instructions which, when executed by a processor, cause the processor to perform the steps of:
providing a map screen comprising a map graphic;
displaying a map legend associated with the map graphic; and
moving the map legend within the map screen.

59. The computer-readable medium according to claim 58, further comprising storing a last placement position of the map legend for replacement of the map legend at the last placement position upon subsequent use of the map screen.

60. The computer-readable medium according to claim 58, wherein the step of providing the map screen comprises displaying a redraw map icon for refreshing the map graphic.

61. The computer-readable medium according to claim 58, wherein the map screen further comprises an input address field that, upon input of address information, determines display of the map graphic.

62. The computer-readable medium according to claim 61, wherein the step of providing the map screen comprises displaying validated address information corresponding to the input address information.

63. The computer-readable medium according to claim 62, wherein the step of providing the map screen further comprises displaying positional information corresponding to the validated address information.

64. The computer-readable medium according to claim 63, wherein the positional information in the step of providing the map screen comprises latitude/longitude information.

65. The computer-readable medium according to claim 58, wherein the step of providing the map screen further comprises requesting information relating to at least one of wire center data, rate center data, PSAP (Public Safety Answering Point) data, CAP (Competitive Access Provider) data, switch collocation data, and switch location data.

66. The computer-readable medium according to claim 58, wherein the step of providing the map screen comprises displaying a plurality of directional icons for panning around the map graphic.

67. A computing device, comprising:
interface means for graphically interfacing between a user and said computing device, using a map screen having a map graphic;
display means for displaying a map legend associated with the map graphic; and
moving means for moving the map legend within the map screen.

68. The computing device according to claim 67, further comprising storing means for storing a last placement position of the map legend for replacement of the map legend at the last placement position upon subsequent use of the map screen.

69. A computing device, comprising:
a communication interface including a processor;
a graphical user interface (GUI) coupled to the communication interface, the GUI comprising,
a map screen having a map graphic and a map legend associated with the map graphic; and
a memory, operatively coupled to the computing device, that stores placement of the map legend within the map screen.

70. The computing device according to claim 69, wherein the memory stores a last placement position of the map legend for replacement of the map legend at the last placement position upon subsequent use of the map screen.

71. The computing device according to claim 69, wherein the map screen displays a redraw map icon to refresh the map graphic.

72. The computing device according to claim 69, wherein the map screen further comprises an input address field that, upon input of address information, determines display of the map graphic.

73. The computing device according to claim 72, wherein the map screen displays validated address information corresponding to the input address information.

74. The computing device according to claim 73, wherein the map screen displays positional information corresponding to the validated address information.

75. The computing device according to claim 74, wherein the positional information comprises latitude/longitude information.

76. The computing device according to claim 69, wherein the memory stores information comprising at least one of wire center data, rate center data, PSAP (Public Safety Answering Point) data, CAP (Competitive Access Provider) data, switch collocation data, and switch location data.

77. The computing device according to claim 69, wherein the map screen displays a plurality of directional icons to pan around the map graphic.

78. A method of interfacing with a computer by a user, the method comprising:
providing a map screen comprising a map graphic;
providing an indication of zoom of the map graphic by positioning a cursor along a zoom bar.

79. The method according to claim 78, further comprising concurrently displaying a zoom distance corresponding to the position of the cursor.

80. The method according to claim 78, wherein the step of providing the map screen comprises:
positioning a cursor along the zoom bar; and
concurrently displaying a zoom distance corresponding to the position of the cursor.

81. The method of claim 80, further comprising activating zooming of the map graphic when the cursor is in a desired position corresponding to a desired level of zoom distance.

82. The method according to claim 80, wherein said zoom bar is continuous and said displaying the zoom distance corresponds to values associated with said zoom bar.

83. The method according to claim 80, wherein said zoom bar comprises discrete areas and said displaying the zoom distance corresponds to values associated with each of said discrete area.

84. The method according to claim 78, wherein the step of providing the map screen comprises displaying a redraw map icon for refreshing the map graphic.

85. The method according to claim 80, wherein the map screen further comprises an input address field that, upon input of address information, determines display of the map graphic.

86. The method according to claim 85, wherein the step of providing the map screen comprises displaying validated address information corresponding to the input address information.

87. The method according to claim 86, wherein the step of providing the map screen further comprises displaying positional information corresponding to the validated address information.

88. The method according to claim 87, wherein the positional information in the step of displaying positional information comprises latitude/longitude information.

89. The method according to claim 78, wherein the step of providing the map screen further comprises requesting information relating to at least one of wire center data, rate center data, PSAP (Public Safety Answering Point) data, CAP (Competitive Access Provider) data, switch collocation data, and switch location data.

90. The method according to claim 78, wherein the step of providing the map screen comprises displaying a plurality of directional icons for panning around the map graphic.

91. A computer-readable medium carrying a sequence of instructions for interfacing with a computer by a user, the sequence of instructions including instructions which, when executed by a processor, cause the processor to perform the steps of:
providing a map screen comprising a map graphic;
providing an indication of zoom of the map graphic by positioning a cursor along a zoom bar.

92. The computer-readable medium according to claim 91, further comprising concurrently displaying a zoom distance corresponding to the position of the cursor.

93. The computer-readable medium according to claim 91, wherein the step of providing the map screen comprises:
positioning a cursor along the zoom bar; and
concurrently displaying a zoom distance corresponding to the position of the cursor.

94. The computer-readable medium of claim 93, further comprising activating zooming of the map graphic when the cursor is in a desired position corresponding to a desired level of zoom distance.

95. The computer-readable medium according to claim 93, wherein said zoom bar is continuous and said displaying the zoom distance corresponds to values associated with said zoom bar.

96. The computer-readable medium according to claim 93, wherein said zoom bar comprises discrete areas and said displaying the zoom distance corresponds to values associated with each of said discrete area.

97. The computer-readable medium according to claim 91, wherein the step of providing the map screen comprises displaying a redraw map icon for refreshing the map graphic.

98. The computer-readable medium according to claim 91, wherein the map screen further comprises an input address field that, upon input of address information, determines display of the map graphic.

99. The computer-readable medium according to claim 98, wherein the step of providing the map screen comprises displaying validated address information corresponding to the input address information.

100. The computer-readable medium according to claim 99, wherein the step of providing the map screen further comprises displaying positional information corresponding to the validated address information.

101. The computer-readable medium according to claim 100, wherein the positional information in the step of providing the map screen comprises latitude/longitude information.

102. The computer-readable medium according to claim 91, wherein the step of providing the map screen further comprises requesting information relating to at least one of wire center data, rate center data, PSAP (Public Safety Answering Point) data, CAP (Competitive Access Provider) data, switch collocation data, and switch location data.

103. The computer-readable medium according to claim 91, wherein the step of providing the map screen comprises displaying a plurality of directional icons for panning around the map graphic.

104. A computing device, comprising:
interface means for graphically interfacing between a user and said computing device, using a map screen having a map graphic;
zoom indication means for providing an indication of zoom of the map graphic by positioning a cursor along a zoom bar.

105. The computing device according to claim 104, further comprising concurrent display means for concurrently displaying a zoom distance corresponding to a position of the cursor.

106. A computing device, comprising:
a communication interface including a processor; and
a graphical user interface (GUI) coupled to the communication interface, the GUI comprising a map screen having a map graphic,
wherein the map screen is configured to display a zoom indication of the map graphic by positioning a cursor along a zoom bar.

107. The computing device according to claim 106, wherein the processor is configured for concurrently displaying a zoom distance corresponding to a position of the cursor.

108. The computing device according to claim 106, wherein the processor configured for providing the map screen is further configured for:
positioning the cursor along the zoom bar; and
concurrently displaying a zoom distance corresponding to a position of the cursor.

109. The computing device of claim 108, wherein the processor is configured for activating zooming of the map graphic when the cursor is in a desired position corresponding to a desired level of zoom distance.

110. The computing device according to claim 108, wherein said zoom bar is continuous and said displaying the zoom distance corresponds to values associated with said zoom bar.

111. The computing device according to claim 108, wherein said zoom bar comprises discrete areas and said displaying the zoom distance corresponds to values associated with each of said discrete area.

112. The computing device according to claim 106, wherein the map screen displays a redraw map icon to refresh the map graphic.

113. The computing device according to claim 106, wherein the map screen further comprises an input address field that, upon input of address information, determines display of the map graphic.

114. The computing device according to claim 113, wherein the map screen displays validated address information corresponding to the input address information.

115. The computing device according to claim 114, wherein the map screen displays positional information corresponding to the validated address information.

116. The computing device according to claim 1 15, wherein the positional information comprises latitude/longitude information.

117. The computing device according to claim 106, wherein the processor is configured for requesting information relating to at least one of wire center data, rate center data, PSAP (Public Safety Answering Point) data, CAP (Competitive Access Provider) data, switch collocation data, and switch location data.

118. The computing device according to claim 106, wherein the map screen displays a plurality of directional icons to pan around the map graphic.
